(19) United States
(12) Patent Application Publication
(10) Pub. No.: US 2008/0208524 A1
(43) Pub. Date: Aug. 28, 2008

(54) SURFACE PROFILE MEASURING INSTRUMENT

(75) Inventors: Ian Carrington Sellars, Cheshire (GB); Peter Ian Baldwin, Cheshire (GB); Philip Anthony May, Lancs (GB); Colin John Morley, Lancs (GB); Brian Leslie Williams, Geary Hallin (GB); Michael Carrington Sellars, Cheshire (GB)

Correspondence Address: SALTER & MICHAELSON;THE HERITAGE BUILDING, 321 SOUTH MAIN STREET, PROVIDENCE, RI, 029037128, US

(73) Assignee: ELCOMETER INSTRUMENTS LIMITED, Manchester (GB)

(21) Appl. No.: 12/034,796

(22) Filed: Feb. 21, 2008

Related U.S. Application Data
(60) Provisional application No. 60/902,419, filed on Feb. 21, 2007.

(51) Int. Cl. G01B 7/28

(52) U.S. Cl. 702/168

(57) ABSTRACT

A surface profile measuring instrument has a means for measuring the profile of a surface and a means for storing measurements produced by the means for measuring the profile of a surface. The instrument may have a tip physically coupled to a sensor. The instrument may also have means for processing the measurements and/or for analysing the measurements. The instrument may be connected to an external device such as a printer and/or to a display unit.

TECHNICAL FIELD OF THE INVENTION

The present invention relates to a surface profile measuring instrument.

### BACKGROUND OF THE INVENTION

Current devices used to measure the profile of a surface exist in both analogue and digital forms. These instruments use a pointed tip which protrudes from an anvil and is connected to either a mechanical or electrical sensor which, in conjunction with a suitably calibrated display means, produces a reading corresponding to the peak to valley height of a surface.

Surface profile readings are generally most useful and provide the most information when a number of readings are recorded for a particular surface. Any trends and patterns in these measurements may then be deduced by analysis. This analysis often takes the form of statistical analysis.

In order for such an analysis to take place, it is necessary to store the measurements. Currently, such measurements are stored by connecting the surface profile measuring device to an external device such as a computer.

Typical surface profile measuring devices are handheld for ease of use. However, having a handheld device connected to such an external device is cumbersome and largely negates the advantages of being handheld.

Furthermore, since it takes time to communicate the measurements to an external device, the measurements cannot be analysed immediately and so time is wasted.

In order to obtain an accurate reading, current surface profile measuring instruments must be used at one specific orientation relative to the measured surface. Since the instruments cannot be used at any angle it is difficult and cumbersome to measure surfaces of certain angles in relation to the user. Specifically it is difficult for a user to read a recorded measurement when the device must be angled away from the user in order to give a valid reading.

### OBJECT OF THE INVENTION

It is the object of embodiments of the present invention to overcome, or at least reduce, the problems discussed above.

### STATEMENTS OF INVENTION

According to the present invention there is provided an instrument comprising means for measuring a profile of a surface and means for storing measurements produced by said means for measuring the profile of a surface.

Preferably the means for measuring the profile of a surface comprises a tip suitably connected to a sensor.

Preferably the shaft comprises means for releasably attaching the tip. This allows the tip to be removed and replaced as required, for example when the tip has become worn done through use due to abrasion with a surface to be measured.

Preferably the tip is physically coupled to the sensor.

Preferably the tip is comprised of a hard wearing material, for example tungsten carbide. This reduces the rate at which the tip is worn away during use through its contact with a surface to be measured, which is often abrasive. Therefore, the instrument may be used for longer periods of time without requiring replacement of the tip.

Preferably the sensor is a linear movement measuring device.

The sensor advantageously comprises at least one potentiometer or at least one transformer or at least one capacitive sensor or at least one encoder.

Preferably the potentiometer is a linear potentiometer.

Preferably the transformer is a linear variable differential transformer.

Preferably the capacitive sensor is a linear symmetric differential capacitance sensor.

Preferably the encoder is a linear encoder.

Preferably the instrument comprises means for transferring the measurements to a computer and/or a printer.

Preferably the instrument comprises means for processing the measurements.

Preferably the instrument comprises means for analysing the measurements.

Preferably the instrument comprises means for statistically analysing the measurements.

Preferably the instrument comprises means for calculating statistical data relating to the measurements.

Preferably the instrument comprises means for calculating an average value of the measurements.

Preferably the instrument comprises means for input of a number of measurements to be taken.

Preferably the instrument comprises means for storing a number of measurements equal to the input number.

Preferably the instrument comprises means for storing the measurements within a group.

Preferably the instrument comprises means for processing the group of measurements.

Preferably the instrument comprises means for analysing the group of measurements.

Preferably the instrument comprises means for statistically analysing the group of measurements.

Preferably the instrument comprises means for calculating statistical data relating to the group of measurements.

Preferably the instrument comprises means for calculating an average value of the group of measurements.

Preferably the instrument comprises means for storing a result of the processing, calculation of statistical data, statistical analysis or calculation of an average value of the measurements or group of measurements.

Preferably the instrument comprises means for automatically recording a measurement when the value of the measurement is stable.

### BRIEF DESCRIPTION OF THE DRAWING FIGURES

In order that the invention may be more clearly understood, one embodiment of the invention will now be described, by way of example, with reference to the accompanying drawings;

FIG. 1 shows an elevational view of a surface profile measuring instrument with a probe tip protruding outside the instrument;

FIG. 2 shows a cross-sectional view to an enlarged scale of the surface profile measuring instrument of FIG. 1 taken along the line A-A of FIG. 1;

FIG. 3 shows an elevational view of a surface profile measuring instrument with a probe tip fully inside the instrument;

FIG. 4 shows a cross-sectional view to an enlarged scale of a surface profile measuring instrument of FIG. 3 taken along the line B-B of FIG. 3;

FIG. 5 shows an elevational view of a surface profile measuring instrument with a probe tip flush with a base of the instrument;

FIG. 6 shows a cross-sectional view to an enlarged scale of a surface profile measuring instrument of FIG. 5 taken along the line C-C of FIG. 5 and

FIG. 7 shows a schematic diagram of a processing unit and its connections to a transformer, an external device, a display unit and an input device.

### DETAILED DESCRIPTION OF THE PREFERRED EMBODIMENT OF THE INVENTION

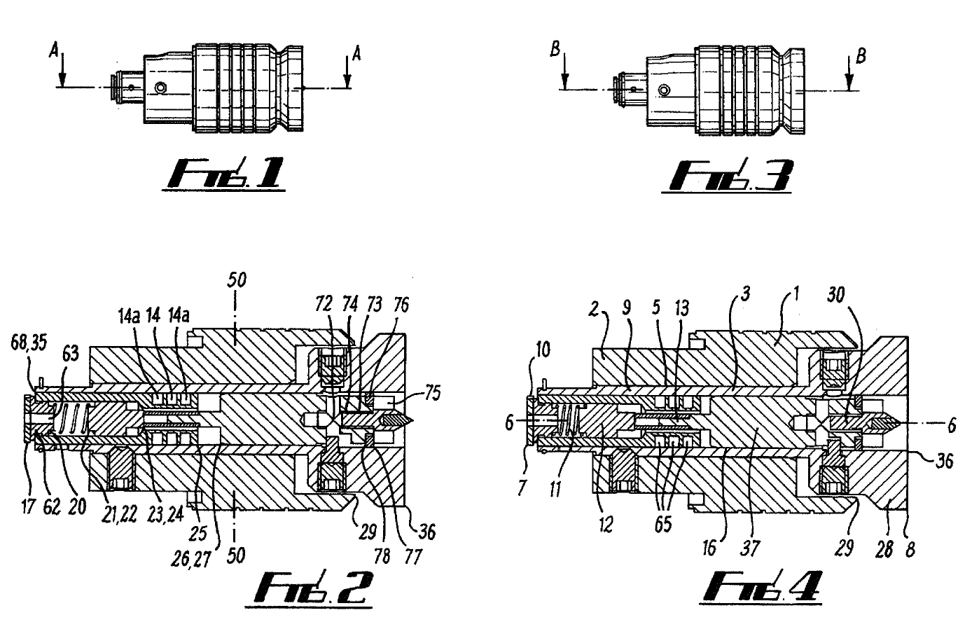

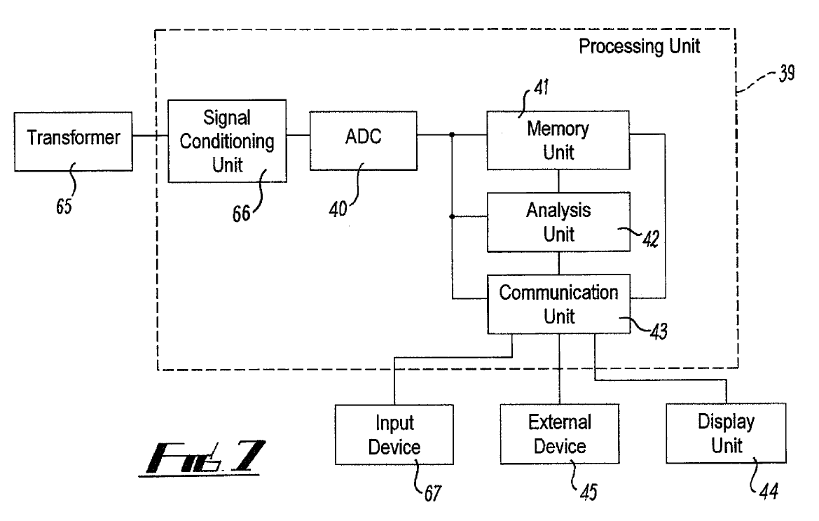

Referring to FIGS. 1-6 there is shown a surface profile measuring instrument 1. The instrument comprises a cylindrical outer enclosure 2, a central body 3, a base 28, a probe 30, a signal processing unit, a display unit and an input device.

The cylindrical outer enclosure 2 forms an outer chamber 5, which is aligned in an axial direction 6. The outer chamber 5 has a first end 68 and a second end 29. The central body 3 is housed within the outer chamber 5. The central body 3 comprises a first end 7 and a second end 8, a cylindrical casing 9, an end piece 10, a spring 11, a piston 12, a tube 13, a linear variable differential transformer 65, a base 28 and a shaft 37.

The cylindrical casing 9 forms an inner chamber 16 which is aligned with the axial direction 6 and extends across the length of the instrument 1. The inner chamber 16 houses the end piece 10, spring 11, piston 12, tube 13 and transformer 65.

The end piece 10 protrudes from a first end 35 of the inner chamber 16 of the cylindrical casing 9 and is disposed within the first end 35 of the inner chamber 16. The end piece 10 acts to close the first end 35 of the inner chamber 16 and acts as a location for the termination of transformer wires (not shown) from the transformer 65.

The end piece 10 comprises a disc 17 and a cylindrical member 62 that is integral with the disc 17. The disc 17 and cylindrical member 62 have a hollow cylindrical shape and a channel 63 that extends in the axial direction 6 towards a second end 36 of the inner chamber 16. The cylindrical member 62 terminates at a point of connection with the spring 11, at a first end 20 of the spring 11. A second end 21 of the spring 11 is constrained to move in the axial direction 6 by virtue of its housing within the inner chamber 16 of the central body 3 and is connected to a first end 22 of the piston 12. The spring 11 holds the piston 12 at a resting position as shown in FIG. 2.

The piston 12 is constrained to reciprocate in the axial direction 6 by virtue of its housing within the inner chamber 16 of the central body 3. A second end 23 of the piston 12 is connected to a first end 24 of the tube 13. The tube 13 extends along the axial direction 6 and passes through an aperture 25 in the inner chamber 16. The tube 13 terminates at its second end 26, at which point it is connected to a first end 27 of the shaft 37. The shaft 37 comprises a non-magnetic material. This is in order to avoid magnetic interference with the transformer 65.

The transformer 65 comprises primary and secondary windings 14, 14a which are disposed along the tube 13 and in a position surrounding the tube 13 to form coupled pairs.

Towards the second end 8 of the central body 3, the central body 3 comprises a portion of increased diameter forming a base 28. In order to accommodate the base 28, towards the second end 29 of the outer chamber 5, the chamber 5 comprises a portion of increased diameter. The inner chamber 16 extends in the axial direction 6 throughout the base 28, with the inner chamber having a constant radius throughout the length in contact with shaft 37.

Towards a second end 64 of the shaft 37, there are provided two cylindrical bores 51, 52 that have perpendicular axes and cross each other at a point of intersection 72.

The bore 51 extends throughout the shaft 37 in a radial direction 50, terminating at an inner surface 53 of the inner chamber 16, at the ends 55, 56 of the bore 51.

A first section of the bore 52 extends in the axial direction 6 from the point of intersection 72 with the bore 51 towards the first end 27 of the shaft 37 and terminates at a first end 57 within the shaft 37. A second section of the bore 52 extends in the axial direction 6, throughout the shaft 37 and terminates at the second end 64 of the shaft 37 to form an aperture 69.

In use, a tip 49 is substantially housed within the second section of the bore 52. The tip 49 extends, from a first end 60, in the axial direction 6 to form a shank section 71. The shank section 71 passes out of the shaft 37 through the aperture 69 in the shaft 37. The shank section 71 decreases in diameter towards the second end 61 of the tip 49 to form a point 70. The shank section 71 of the tip 49 comprises a threaded portion 73. The bore 52 is provided with a complimentary threaded portion 74. The tip 49 may be releasably attached to the shaft 37 by engaging the threaded portion 73 of the shank section 71 with the threaded portion 74 of the bore 52.

The tip 49 preferentially comprises a flange 75, within which two recesses are machined to allow the tip 49 to be removed using a suitable tool. A compressible washer 76 is held between a face 77 of the flange 75 and an opposing face 78 of the shaft 37. The washer 76 prevents dust and grit from entering the inner chamber 16.

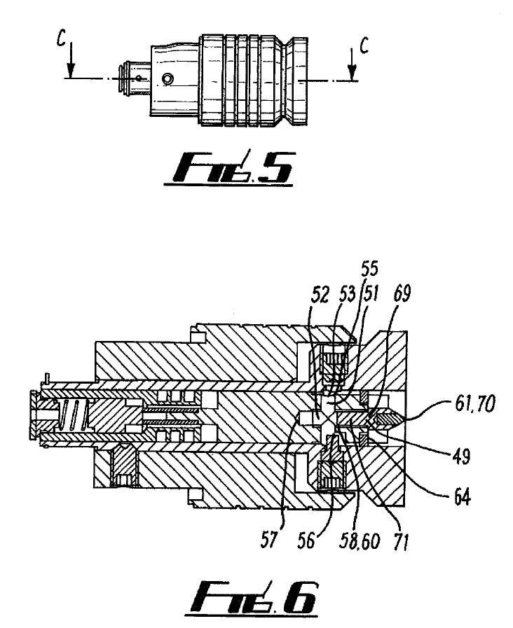

The tip 49, through its interaction with the shaft 37, tube 13, piston 12, spring 11 and end piece 10 is able to move between a first position (shown on FIG. 2) and a second position (shown on FIG. 4). In the first position the tip 49 is partially protruding from the base 28, as shown in FIGS. 1 and 2. In the second position the tip 49 is fully inside the base 28, as shown in FIGS. 3 and 4.

When the instrument is placed onto a surface to be measured, the base 28 abuts against the highest “peak” on the surface. The tip 49 is urged by the spring 11 through the interaction of the piston 12, tube 13, shaft 37 and tip 49 to abut against the surface.

The primary and secondary windings of the transformer 14, 14a are arranged such that as tip 49 and hence the tube 13 moves, the electrical coupling between the primary and secondary windings 14, 14a is varied in proportion to the movement of the tip 49. Therefore, a variable electrical signal is produced, by the transformer 65 in proportion to the peak to valley height of indentations in the surface. The tube 13 has high magnetic permeability.

Referring to FIG. 7, the transformer 65 is electrically connected to the processing unit 39. The processing unit 39 comprises a signal conditioning unit 66, an analogue to digital converter 40, a memory unit 41, an analysis unit 42 and a communication unit 43.

The processing unit 39 receives the electrical signals from the transformer 65. The signals pass to the signal conditioning unit 66 which modifies the signals to make them suitable for input to the analogue to digital converter 40. The signals pass from the signal conditioning unit to the analogue to digital converter 40, which digitises the analogue signals originally produced by the transformer 65.

The analogue to digital converter 40 is connected to the memory unit 41, the analysis unit 42 and the communication unit 43.

The signals from the analogue to digital converter 40 correspond to measurement values and can pass directly to the memory unit 41 to be stored as data, or directly to the analysis unit 42 for analysis, such as statistical analysis, or directly to the communication unit 43 for communication of the measurement values to an external device 45, such as a computer or a printer or to the display unit 44. The display unit is suitably arranged such that a user of the instrument can easily read the measurement values.

The memory unit 41 is connected to the analogue to digital converter 40, the analysis unit 42 and the communication unit 43. The memory unit 41 comprises a means for storing the signals from the analogue to digital converter 40. The memory unit 41 is connected to the analysis unit and further comprises means for storing data produced by the analysis unit 42. This allows the memory unit 41 to store the data produced by the analysis unit 42. This connection also allows the analysis unit 42 to retrieve data from the memory unit 41.

The memory unit 41 further comprises means for storing measurements from the analogue to digital converter 40 or data from the analysis unit 42 as data separated into distinct groups as well as storing a plurality of the groups.

The analysis unit 42 comprises means for analysing the signals from the analogue to digital converter 40 or data from the memory unit 41. This analysis may take the form of a calculation of statistical data, such as by statistical analysis. An example of a method of statistical analysis that may be used is averaging.

An input device 67 is connected to the communication unit 43. The input device 67 receives input commands from a user of the instrument 1 and translates the commands into signals that pass to the communication unit 43. In response to the input signals, the communication unit 43 may send or request data to or from the analysis unit 42 and/or the memory unit 41 or the communication unit 43 may send data to the display unit 44.

The input device 67 and display unit 44 and/or external device 45 may be suitably connected to the communication unit 43 such that they form a graphical user interface. An example of a graphical user interface that may be used is a hierarchical menu system. This facilitates navigation, by the user, through the available input command options.

An example of an input command is a number corresponding to a number of measurements to be taken. This input passes from the input device 67 to the communication unit 43 and subsequently to the analysis unit 42 and/or the memory unit 41. The memory unit 41 will then store a number of measurement readings equal to the input number.

The communication unit 43 is connected to the analogue to digital converter 40, the analysis unit 42, the memory unit 41, the external device 45, the input device 67 and the display unit 44.

The connection between the communication unit 43 and the external device 45 may be by wired or wireless means. An example of wireless means that may be used is via Bluetooth connectivity.

The above arrangement has been described by way of example only and many variations are possible without departing from the scope of the invention.

1. An instrument comprising means for measuring the profile of a surface and means for storing measurements produced by said means for measuring the profile of a surface.

2. An instrument according to claim 1 wherein the means for measuring the profile of a surface comprises a tip suitably connected to a sensor.

3. An instrument according to claim 2 comprising a means for releasably attaching the tip.

4. An instrument according to claim 2 wherein the tip is physically coupled to the sensor.

5. An instrument according to claim 2 wherein the tip is comprised of tungsten carbide or similar hard wearing material.

6. An instrument according to claim 2 wherein the sensor is a linear movement measuring device.

7. An instrument according to claim 6 wherein the sensor comprises at least one potentiometer.

8. An instrument according to claim 6 wherein the sensor comprises at least one transformer.

9. An instrument according to claim 8 wherein the transformer is a variable transformer.

10. An instrument according to claim 6 wherein the sensor comprises at least one capacitive sensor.

11. An instrument according to claim 6 wherein the sensor comprises at least one encoder.

12. An instrument according to claim 1 wherein the instrument comprises means for transferring the measurements to a computer and/or a printer.

13. An instrument according to claim 1 wherein the instrument comprises means for processing the measurements.

14. An instrument according to claim 1 wherein the instrument comprises means for analysing the measurements.

15. An instrument according to claim 14 wherein the instrument comprises means for statistically analysing the measurements.

16. An instrument according to claim 15 wherein the instrument comprises means for calculating an average value of the measurements.

17. An instrument according to claim 1 wherein the instrument comprises means for input of a number of measurements to be taken.

18. An instrument according to claim 17 wherein the instrument comprises means for storing a number of measurements equal to the input number.

19. An instrument according to claim 1 wherein the instrument comprises means for storing the measurements within a group.

20. An instrument according to claim 19 wherein the instrument comprises means for processing the group of measurements.

21. An instrument according to claim 19 wherein the instrument comprises means for analysing the group of measurements.

22. An instrument according to claim 19 wherein the instrument comprises means for statistically analysing the group of measurements.

23. An instrument according to claim 19 wherein the instrument comprises means for calculating an average value of the group of measurements.

24. An instrument according to claim 20 wherein the instrument comprises means for storing a result of the processing.

25. An instrument according to claim 22 wherein the instrument comprises means for storing a result of the statistical analysis.

26. An instrument according to claim 23 wherein the instrument comprises means for storing a result of the calculation of an average value of the measurements or group of measurements.

27. An instrument according to claim 1 wherein the instrument comprises means for automatically recording a measurement when the value of the measurement is stable.

28. An instrument according to claim 1 wherein the instrument comprises a display means.

29. An instrument according to claim 28 wherein the display means is suitable for displaying a graphical user interface.

30. An instrument according to claim 29 wherein the graphical user interface comprises a hierarchical menu system.
